(19) United States
(12) Patent Application Publication
(10) Pub. No.: US 2011/0026637 A1
(43) Pub. Date: Feb. 3, 2011

(54) METHOD AND APPARATUS FOR TRANSMITTING PILOT SIGNAL IN A MULTIPLE INPUT MULTIPLE OUTPUT WIRELESS COMMUNICATION SYSTEM

(75) Inventors: Wook Bong Lee, Anyang-si (KR); Su Nam Kim, Anyang-si (KR); Bin Chul Ihm, Anyang-si (KR); Jin Young Chun, Anyang-si (KR)

Correspondence Address: LEE, HONG, DEGERMAN, KANG & WAIMEY, 660 S. FIGUEROA STREET, Suite 2300, LOS ANGELES, CA, 90017, US

(73) Assignee: LG ELECTRONICS INC.

(21) Appl. No.: 12/847,998

(22) Filed: Jul. 30, 2010

Related U.S. Application Data
(60) Provisional application No. 61/229,723, filed on Jul. 30, 2009.

(30) Foreign Application Priority Data
Apr. 8, 2010 (KR) 10-2010-32188

(51) Int. Cl. H04L 27/00

(52) U.S. Cl. 375/295

(57) ABSTRACT

A method and apparatus for transmitting a pilot signal in a Multiple Input Multiple Output (MIMO) wireless communication system are disclosed. The method sets a power of pilot signal to be transmitted in a pilot pattern according to a predefined ratio of a total power of the pilot signal to a total power of data tones being transmitted together with the pilot signal on a subframe.

This application claims the benefit of U.S. Patent Application No. 61/229,723, filed on Jul. 30, 2009 and Korean Patent Application No. 10-2010-32188, filed on Apr. 8, 2010, which are hereby incorporated by reference as if fully set forth herein.

### BACKGROUND OF THE INVENTION

1. Field of the Invention

The present invention relates to a wireless communication system, and more particularly, to a method and apparatus for transmitting a pilot signal in a Multiple Input Multiple Output (MIMO) wireless communication system.

2. Discussion of the Related Art

Channel estimation and a pilot signal will be described below in brief.

To detect a synchronization signal, a receiver should get knowledge of information about a radio channel (e.g. the attenuation, phase shift or time delay of the radio channel). Channel estimation is the process of estimating the amplitude and reference phase of a carrier. In a wireless channel environment, a radio channel experiences irregular variations of channel status in the time and frequency domains over time, namely fading. Hence, channel estimation is to estimate the amplitude and phase of the radio channel, specifically the frequency response of a radio link or the radio channel.

For channel estimation, reference values may be estimated based on pilot symbols received from a Base Station (BS) using a two-dimensional channel estimator. Pilots do not carry actual data but have high power to help carrier phase synchronization and BS information acquisition. A transmitter and a receiver may perform channel estimation using pilots. The pilot-based channel estimation is to estimate a channel using pilots known to both the transmitter and the receiver and recover data using the channel estimate.

In Institute of Electrical and Electronics Engineers (IEEE) 802.16m, two modes are largely defined for subchannelization, localized mode and diversity mode. In general, Contiguous Resource Units (CRUS) are used in the localized mode, whereas Distributed Resource Units (DRUs) are used in the diversity mode.

Pilot patterns for downlink CRUs and DRUs and uplink CRUs of IEEE 802.16m are illustrated in FIGS. 1 to 11.

FIG. 1 illustrates pilot patterns for one stream and FIGS. 2 and 3 illustrate pilot patterns for two streams.

The pilot patterns illustrated in FIGS. 1, 2 and 3 are designed for a 6-symbol frame. If a subframe includes 5 symbols, a pilot pattern for the 5-symbol subframe is obtained by eliminating the last symbol of the 6-symbol frame. In the case of a 7-symbol subframe, a pilot pattern is designed by adding the first Orthogonal Frequency Division Multiplexing (OFDM) symbol as the 7^{th} OFDM symbol, that is, the last OFDM symbol.

FIGS. 4, 5 and 6 illustrate pilot patterns for three streams, FIGS. 7 to 10 illustrate pilot patterns for four streams, and FIG. 11 illustrates pilot patterns for 5 to 8 streams.

Pilot patterns for uplink DRUs in IEEE 802.16m are illustrated in FIGS. 12 and 13. Specifically, FIG. 12 illustrates pilot patterns for one stream and FIG. 13 illustrates pilot patterns for two streams.

Pilot patterns for distributed Partially Used SubCarrier (PUSC) Logical Resource Units (LRUs) in IEEE 802.16m are illustrated in FIGS. 14 and 15. Specifically, FIG. 14 illustrates pilot patterns for one stream and FIG. 15 illustrates pilot patterns for two streams.

Meanwhile, the MIMO technology to which the present invention is applied will be described in brief.

MIMO is short for Multiple Input Multiple Output. Beyond the traditional use of a single transmission antenna and a single reception antenna, MIMO increases transmission and reception data efficiency by adopting multiple transmission antennas and multiple reception antennas. That is, data segments received through a plurality of antennas are collected to a complete message, without depending on a single antenna path in MIMO. The MIMO technology increases data rate within a predetermined coverage area or expands system coverage for a given data rate. In this context, MIMO is a future-generation mobile communication technology that may find its usage in a wide range including User Equipments (UEs) and relays. Also, MIMO is attracting interest as a promising technology to overcome the limit of transmission capacity in mobile communications, which has been reached due to increased data communication.

FIG. 17 illustrates the configuration of a typical MIMO system.

Referring to FIG. 17, the use of an increased number of antennas at both a transmitter and a receiver increases a theoretical transmission capacity in proportion to the number of antennas, thereby increasing frequency efficiency significantly.

Since the theoretical capacity increase of the MIMO system was proved in the middle 1990's, many techniques have been actively studied to increase data rate in real implementation. Some of the techniques have already been reflected in various wireless communication standards for 3^{rd} Generation (3G) mobile communications, future-generation Wireless Local Area Network (WLAN), etc.

Active studies are underway in many respects regarding the MIMO technology, inclusive of studies of information theory related to calculation of MIMO communication capacity in diverse channel environments and multiple access environments, studies of measuring radio channels and deriving a model for a MIMO system, studies of time-space signal processing techniques to increase transmission reliability and transmission rate, etc.

There are two types of MIMO schemes: spatial diversity and spatial multiplexing. Spatial diversity increases transmission reliability using symbols that have passed in multiple channel paths, whereas spatial multiplexing increases transmission rate by transmitting a plurality of data symbols simultaneously through a plurality of transmission antennas. Taking the advantages of these two schemes is a recent active study area.

FIG. 16 illustrates a downlink MIMO architecture of a transmitter.

Referring to FIG. 16, a MIMO encoder 201 maps L (≧1) layers to Mₜ (≧L) streams. A layer is defined as a coding and modulation path input to the MIMO encoder 201, and a stream is defined as an output of the MIMO encoder 201 applied to a precoder 202.

The precoder 202 maps the streams received from the MIMO encoder 201 to antennas by generating antenna-specific data symbols according to a selected MIMO mode.

Subcarrier mappers 203 map the antenna-specific data to OFDM symbols.

The layer-to-stream mapping is carried out by the MIMO encoder 201. The MIMO encoder 201 is a batch processor that processes M input symbols at one time. The input of the MIMO encoder 201 may be an M×1 vector expressed as

$$s = [ \begin{matrix}{s}_{1} \\ {s}_{2} \\ ⋮ \\ {s}_{M}\end{matrix} ] \qquad [ Equation 1 ]$$

where Sᵢ denotes an i^{th} input of the batch. The layer-to-stream mapping of the input symbols first takes place in the space dimension.

The output of the MIMO encoder 201 may be given as an Mₜ×N_{F} MIMO Space Time Coding (STC) matrix expressed as

x=S(s) [Equation 2]

where Mₜ denotes the number of streams, N_{F} denotes the number of subcarriers occupied by one MIMO block, x denotes the output of the MIMO encoder 201, s denotes the input layer vector, and S(s) denotes the STC matrix.

The output of the MIMO encoder 201, x is represented as

$$x = [ \begin{matrix}{x}_{1 , 1} & {x}_{1 , 2} & ⋯ & {x}_{1 , {N}_{F}} \\ {x}_{2 , 1} & {x}_{2 , 1} & ⋯ & {x}_{2 , {N}_{F}} \\ ⋮ & ⋮ & ⋱ & ⋮ \\ {x}_{{M}_{t} , 1} & {x}_{{M}_{t} , 2} & ⋯ & {x}_{{M}_{t} , {N}_{F}}\end{matrix} ] \qquad [ Equation 3 ]$$

In Single User MIMO (SU-MIMO) transmission, an STC rate is defined as

$$R = \frac{M}{{N}_{F}} \qquad [ Equation 4 ]$$

In Multiple User MIMO (MU-MIMO) transmission, an STC rate per layer is 1.

Space Frequency Block Coding (SFBC), Vertical Encoding (VE) and Horizontal Encoding (HE) are available as the format of the MIMO encoder 201.

If the MIMO encoder 201 employs SFBC, the input of the MIMO encoder 201 may be given as the following 2×1 vector.

$$s = [ \begin{matrix}{s}_{1} \\ {s}_{2}\end{matrix} ] \qquad [ Equation 5 ]$$

Then the MIMO encoder 201 generates the following SFBC matrix expressed as

$$x = [ \begin{matrix}{s}_{1} & - {s}_{2}^{*} \\ {s}_{2} & {s}_{1}^{*}\end{matrix} ] \qquad [ Equation 6 ]$$

where the SFBC matrix x is a 2×2 matrix, and occupies two consecutive subcarriers.

In VE, the input and output of the MIMO encoder 201 are expressed as the following M×1 vector.

$$x = s = [ \begin{matrix}{s}_{1} \\ {s}_{2} \\ ⋮ \\ {s}_{M}\end{matrix} ] \qquad [ Equation 7 ]$$

where sᵢ denotes an i^{th} input symbol of the batch and the input symbols s₁ . . . s_{M} belong to the same layer in VE.

In HE, the input and output of the MIMO encoder 201 are also expressed as the following M×1 vector.

$$x = s = [ \begin{matrix}{s}_{1} \\ {s}_{2} \\ ⋮ \\ {s}_{M}\end{matrix} ] \qquad [ Equation 8 ]$$

where sᵢ denotes an i^{th} input symbol of the batch and the input symbols s₁ . . . s_{M} belong to different layers in HE.

Streams are mapped to antennas in the following manner.

The precoder 202 is configured to map streams to antennas. Specifically, the precoder 202 multiplies the output of the MIMO encoder 201 by a Nₜ×Mₜ precoding matrix, W. The output of the precoder 202 is denoted by an Nₜ×N_{F} matrix, z, which is expressed as

$$\begin{matrix}z = Wx \\ = [ \begin{matrix}{z}_{1 , 1} & {z}_{1 , 2} & ⋯ & {z}_{1 , {N}_{F}} \\ {z}_{2 , 1} & {z}_{2 , 1} & ⋯ & {z}_{2 , {N}_{F}} \\ ⋮ & ⋮ & ⋱ & ⋮ \\ {z}_{{N}_{t} , 1} & {z}_{{N}_{t} , 2} & ⋯ & {z}_{{N}_{t} , {N}_{F}}\end{matrix} ] \\ = [ {w}_{1} {w}_{2} {…w}_{{M}_{t}} ] [ \begin{matrix}{x}_{1 , 1} & {x}_{1 , 2} & ⋯ & {x}_{1 , {N}_{F}} \\ {x}_{2 , 1} & {x}_{2 , 1} & ⋯ & {x}_{2 , {N}_{F}} \\ ⋮ & ⋮ & ⋱ & ⋮ \\ {x}_{{M}_{t} , 1} & {x}_{{M}_{t} , 2} & ⋯ & {x}_{{M}_{t} , {N}_{F}}\end{matrix} ]\end{matrix} \qquad [ Equation 9 ]$$

where Nₜ denotes the number of transmission antennas and z_{j,k}, denotes an output symbol transmitted on a k^{th} subcarrier through a j^{th} physical antenna.

On a downlink, a BS determines the number of transmission streams Mₜ that a UE will receive and a pilot pattern for the transmission streams according to a MIMO mode. A set of pilot patterns can be determined according to Cell_ID assigned to the BS. For example, a pilot pattern set can be determined by

pₖ=mod(Cell_ID,3)

where pₖ denotes the index of a pilot pattern. The pilots of an i^{th} stream are multiplied by a predetermined precoding matrix wᵢ.

On an uplink, the BS determined the number of transmission streams, Mₜ in a transmission MIMO mode of a UE. The UE determines a pilot pattern according to the transmission MIMO mode, permutation (DRU/PUSC/CRU), and the total number of streams (the number of streams available to all UEs within a cell in an area) and multiplies the pilot of an i^{th} stream by a predetermined precoding matrix wᵢ, prior to transmission. For one or two streams, set 1 is used among the pilot patterns.

Pilot boosting is used to increase the performance of channel estimation. However, the power of data tones decreases as pilots are boosted to a higher power level. It is because the total transmit power available in a device is limited. Accordingly, there exists a need for setting a boosting level according to a situation.

### SUMMARY OF THE INVENTION

Accordingly, the present invention is directed to a method and apparatus for transmitting a pilot signal in a MIMO wireless communication system that substantially obviate one or more problems due to limitations and disadvantages of the related art.

An object of the present invention is to provide a method and apparatus for transmitting a pilot signal in a MIMO system.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for transmitting a pilot signal in a MIMO wireless communication system includes: setting a pilot power for a pilot signal to be transmitted in a pilot pattern, and transmitting a subframe including a data stream and the pilot pattern of the pilot signal. A ratio of a total power of the pilot signal to a total power of the data stream is preset in the system.

The method may further includes: determining the pilot pattern for use in channel estimation.

For one or two data streams, the ratio of the total power of the pilot signal to the total power of the data streams may be preset to 1.58:1.

For three to eight streams, the ratio of the total power of the pilot signal to the total power of the data streams may be preset to 1:1.

The pilot signal may be transmitted on a downlink.

For one to four streams, the ratio of the total power of the pilot signal to the total power of the data streams may be preset to 1:1.

The pilot signal may be transmitted on an uplink.

In another aspect of the present invention, a base station in a MIMO wireless communication system includes a processor configured to set a pilot power for a pilot signal to be transmitted in a pilot pattern; and a transmitter, electrically connected to the processor, configured to transmit a subframe including a data stream and the pilot pattern of the pilot signal. A ratio of a total power of the pilot signal to a total power of the data stream is preset in the system.

The processor is further configured to determine the pilot pattern for use in channel estimation.

The base station further includes: a receiver, electrically connected to the processor, configured to receive channel information between the base station and a user equipment from the user equipment, the channel information being acquired using the pilot signal by the user equipment.

For one or two data streams, the ratio of the total power of the pilot signal to the total power of the data streams may be preset to 1.58:1.

For three to eight streams, the ratio of the total power of the pilot signal to the total power of the data streams may be preset to 1:1.

In a further aspect of the present invention, a user equipment in a MIMO wireless communication system includes: a processor configured to set a pilot power for a pilot signal to be transmitted in a pilot pattern; and a transmitter, electrically connected to the processor, configured to transmit a subframe including a data stream and the pilot signal. A ratio of a total power of the pilot signal to a total power of the data stream is preset in the system.

The processor is further configured to determine the pilot pattern for use in channel estimation.

The user equipment further includes: a receiver, electrically connected to the processor, configured to receive channel information between a base station and the use equipment from the base station, the channel information being acquired using the pilot signal by the base station

For one to four streams, the ratio of the total power of the pilot signal to the total power of the data streams may be preset to 1:1.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates pilot patterns of one stream.

FIGS. 2 and 3 illustrate pilot patterns for two streams.

FIGS. 4, 5 and 6 illustrate pilot patterns for three streams.

FIGS. 7 to 10 illustrate pilot patterns for four streams.

FIG. 11 illustrates pilot patterns for five to eight streams.

FIG. 12 illustrates pilot patterns for one stream for uplink Distributed Resource Units (DRUs).

FIG. 13 illustrates pilot patterns for two streams for uplink DRUs.

FIG. 14 illustrates pilot patterns for one stream for distributed Partially Used SubCarrier (PUSC) Logical Resource Units (LRUs).

FIG. 15 illustrates pilot patterns for two streams for distributed PUSC LRUs.

FIG. 16 illustrates a downlink MIMO architecture of a transmitter.

FIG. 17 illustrates the configuration of a general MIMO system.

FIG. 18 is a flowchart illustrating a method for transmitting a pilot signal according to an embodiment of the present invention.

FIG. 19 is a block diagram of a device applicable to both a Base Station (BS) and a User Equipment (UE), for implementing the present invention.

### DETAILED DESCRIPTION OF THE INVENTION

Exemplary embodiments of the present invention are supported by standard documents disclosed for at least one of wireless access systems including an Institute of Electrical and Electronics Engineers (IEEE) 802.16m system, Generation Project Partnership (3GPP) system, a 3GPP Long Term Evolution (LTE) system, and a 3GPP2 system. In particular, the steps or parts, which are not described to clearly reveal the technical idea of the present invention, in the embodiments of the present invention may be supported by the above documents.

Specific terms used for the exemplary embodiments of the present invention are provided to help the understanding of the present invention. These specific terms may be replaced with other terms within the scope and spirit of the present invention.

Pilot boosting is used to increase the performance of channel estimation. However, as pilots are boosted to a higher power level, the power of data tones decreases. Accordingly, it is significant to set a boosting level appropriately according to a situation.

A method for transmitting a pilot signal will first be described.

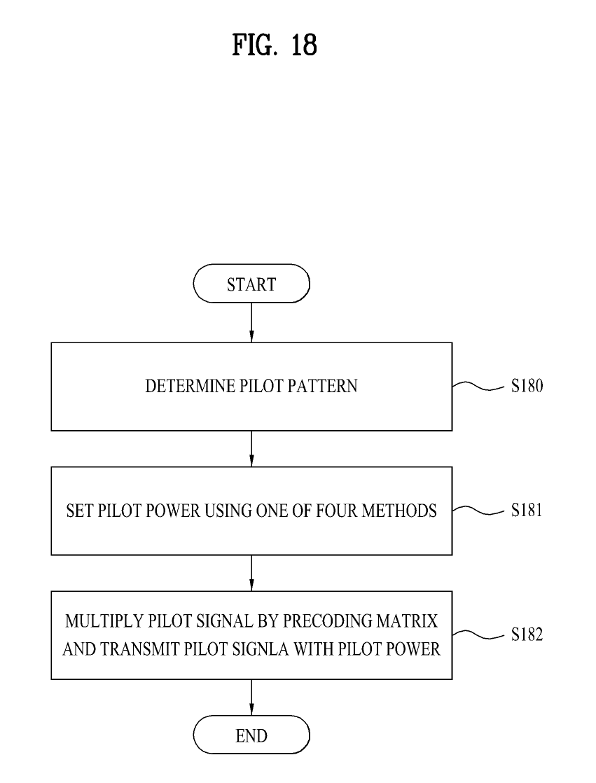

FIG. 18 is a flowchart illustrating a method for transmitting a pilot signal according to an embodiment of the present invention.

Referring to FIG. 18, a pilot pattern is first determined in step S180 and the transmit power of a pilot signal is controlled in step S181. The pilot power may be set by one of the following four methods. Then the pilot signal is multiplied by a precoding matrix and transmitted with the determined transmit power in step S182.

Now a description will be made of methods for controlling the transmit power of a pilot signal according to the present invention.

A pilot boosting level may be defined as a pilot power relative to a data tone power for each data/transmit stream.

The pilot patterns may support variable pilot boosting. When pilots are boosted, each data subcarrier have the same transmit power across all OFDM symbols in a resource block.

With the pilot boosting level defined above, two methods for setting a power boosting level on a downlink will be described below. Table 1 below illustrates an example of setting pilot boosting levels according to first and second methods (Method 1 and Method 2) according to embodiments of the present invention.

TABLE 1

| | | Method 1 | | Method 2 | |
|---|---|---|---|---|---|
| Number | Power per | Pilot | | Pilot | |
| of data | data | boosting | Pilot | boosting | Pilot |
| streams | stream | level | power | level | power |
| 1 | 1 | 5 dB | 3.16 | 2 dB | 1.58 |
| 2 | 0.5 | 5 dB | 1.58 | 5 dB | 1.58 |
| 3 | 0.3333 | 6 dB | 1.33 | 4.8 dB | 1 |
| 4 | 0.25 | 6 dB | 1.00 | 6 dB | 1 |
| 5 | 0.2 | 6 dB | 0.80 | 7 dB | 1 |
| 6 | 0.1667 | 6 dB | 0.66 | 7.8 dB | 1 |
| 7 | 0.1429 | 6 dB | 0.57 | 8.5 dB | 1 |
| 8 | 0.125 | 6 dB | 0.50 | 9 dB | 1 |

Referring to [Table 1], a pilot boosting level is fixed with respect to a power of each stream in Method 1. For example, given one data stream, if the power of the data stream is 1, the pilot boosting level may be fixed to 5 dB. According to Method 1, a large number of streams are allocated to a user in a good channel status, that is, a user having a high long-term Signal-to-Noise ratio (SNR). Channel estimation performance increases with the long-term SNR. Therefore, if the number of streams increases, the channel estimation performance is maintained despite a decreased pilot power.

Method 2 is to fix the pilot power. The total transmit power of OFDM symbols varies with the number of streams. Accordingly, Method 2 maintains the total transmit power of OFDM symbols with respect to a total data tone power according to the number of streams. For example, for one data stream, a power per data stream is 1 and the pilot power is fixed to 1.58. According to the definition above, the power boosting level for one data stream is 10*log(pilot power/(power per data stream))=10*log(1.58/(1/1))≈2 dB. For another example, for three data streams, a power per data stream is ⅓ and the pilot power per stream is 1. According to the definition above, the power boosting level for three data streams is 10*log(1/(⅓))=4.8 dB.

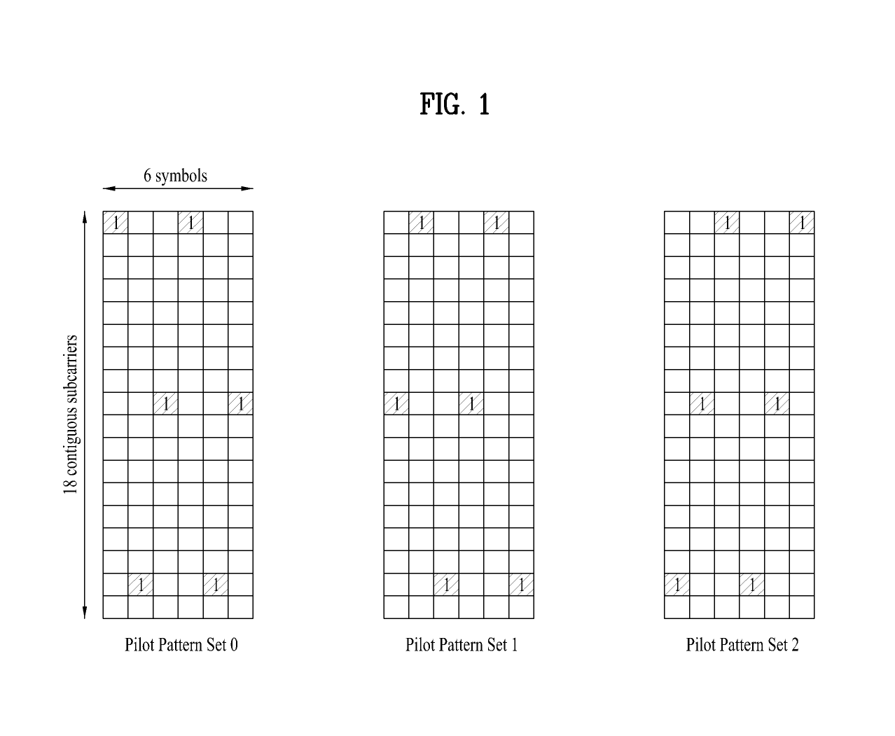

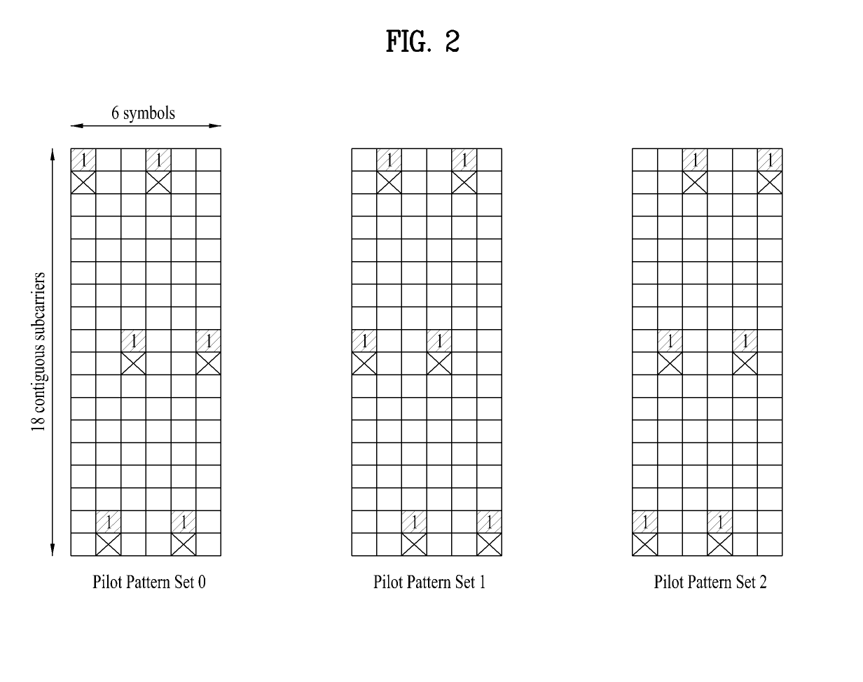

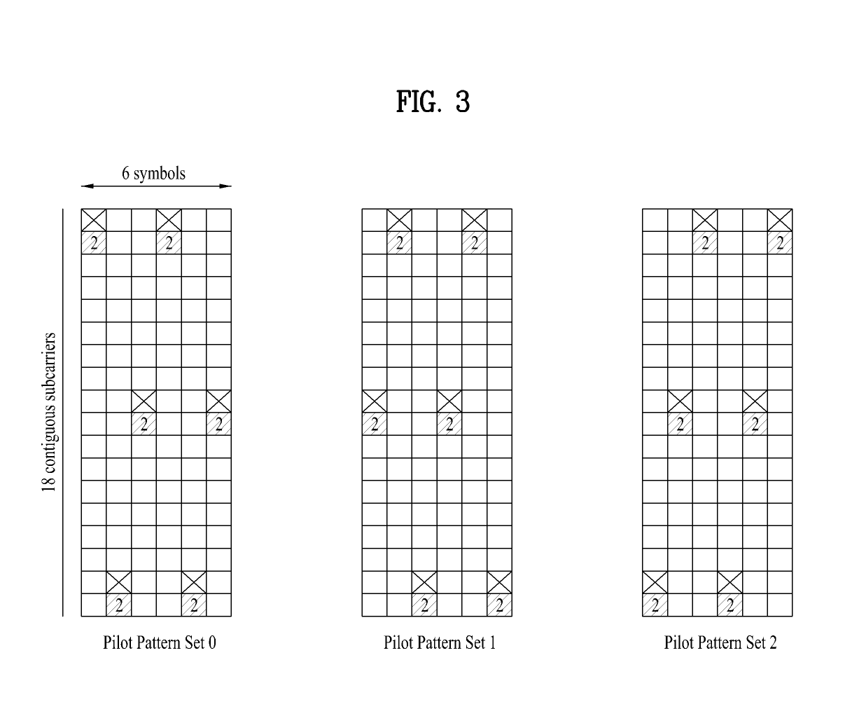

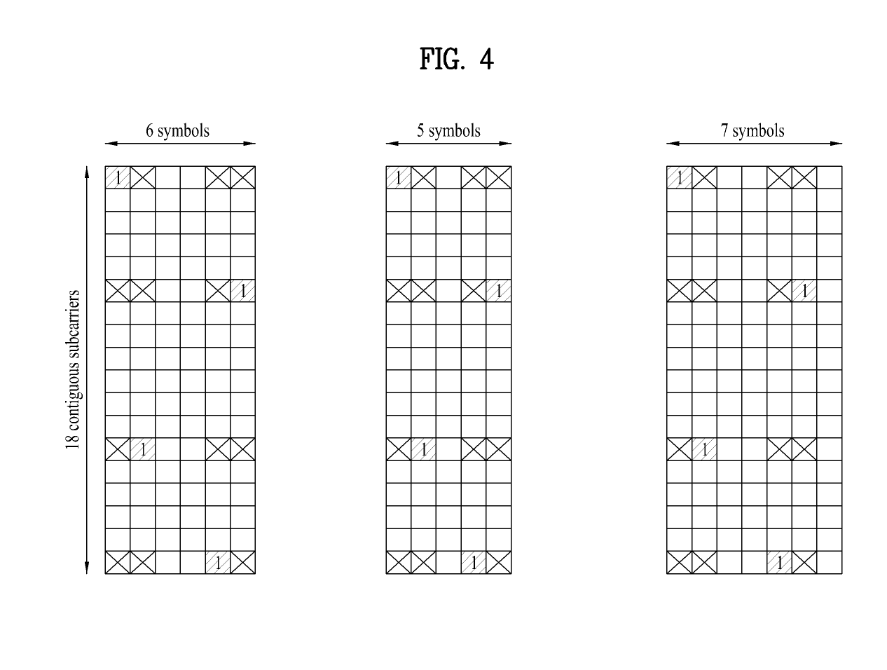

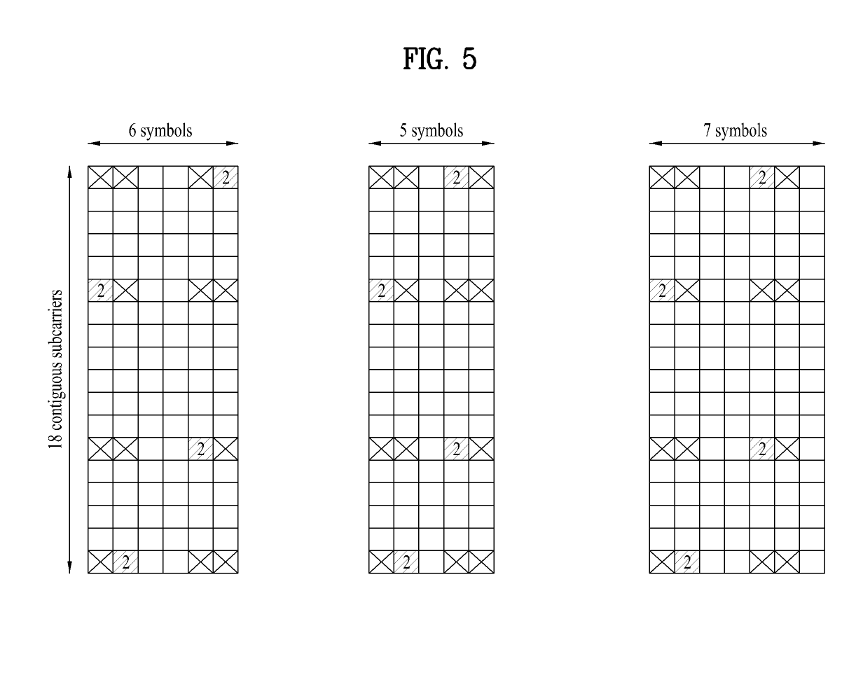

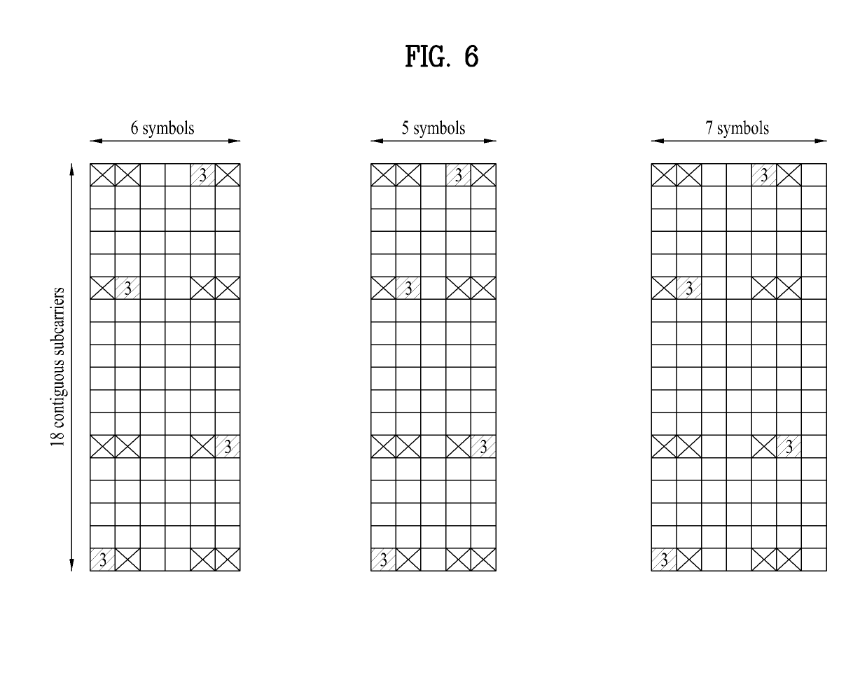

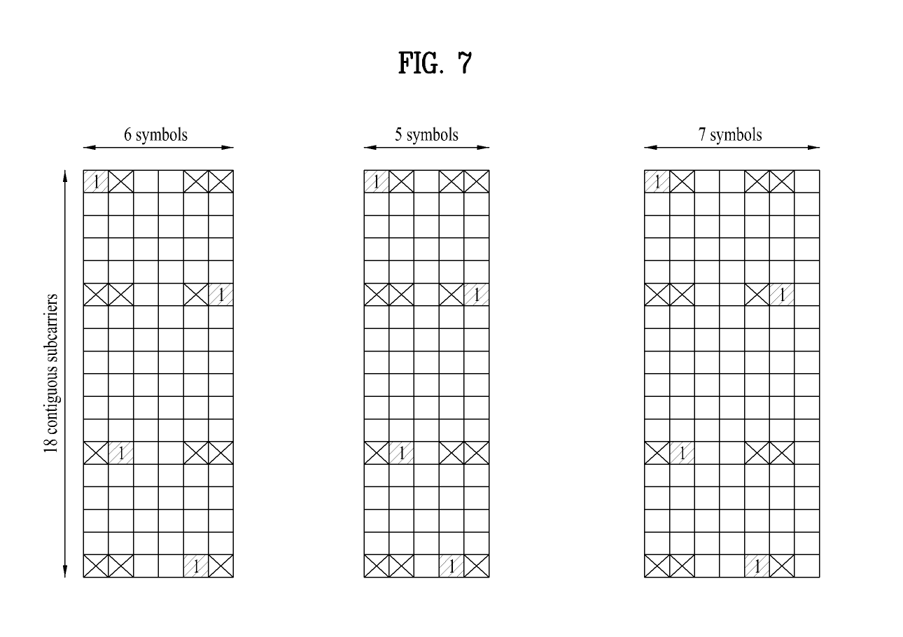

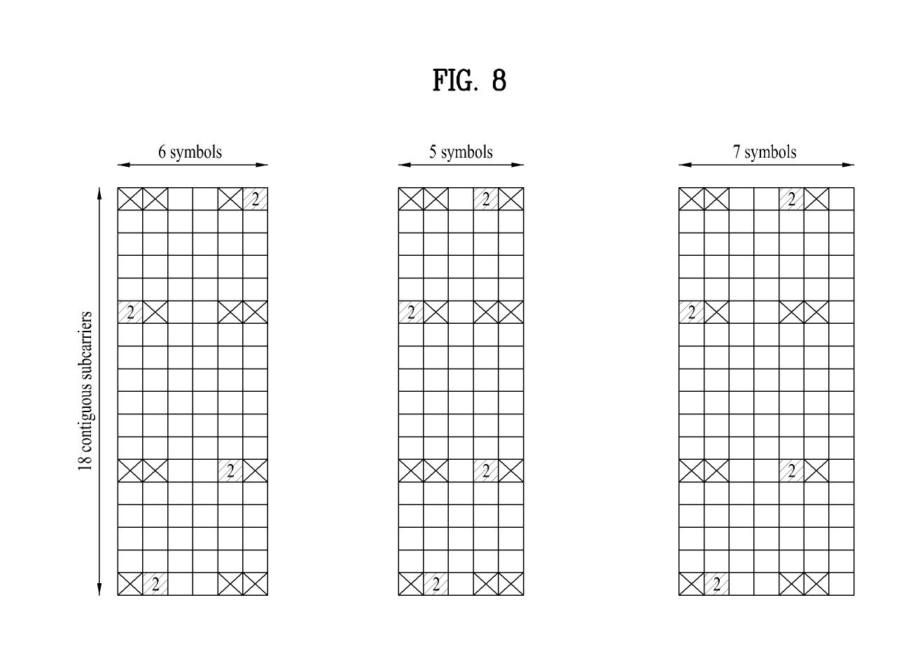

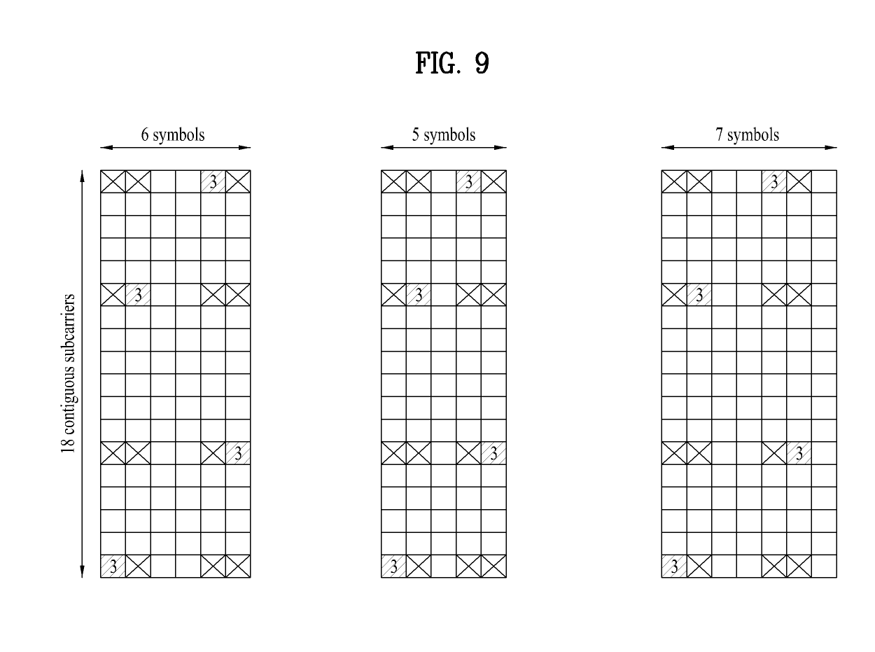

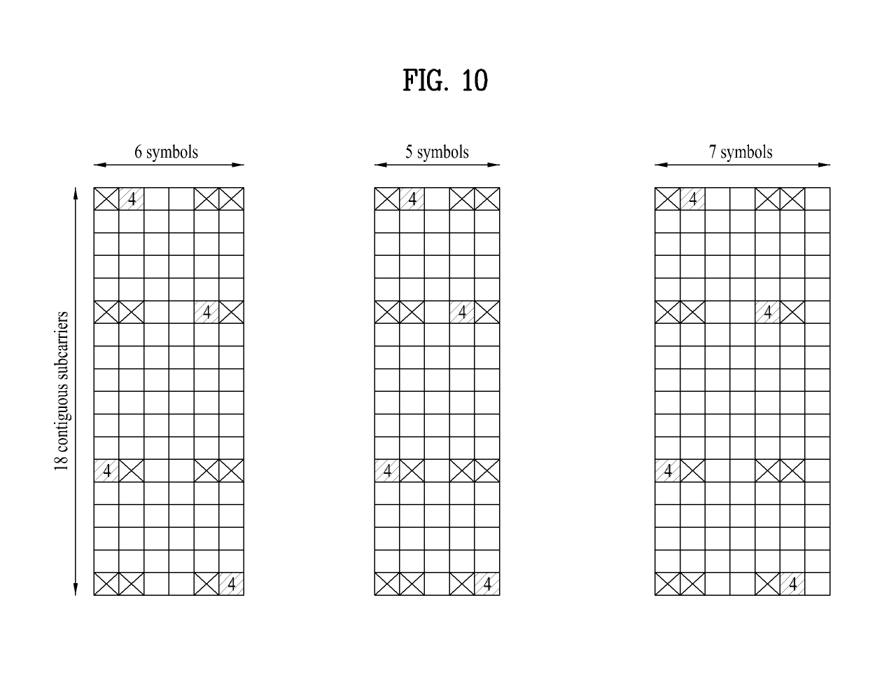

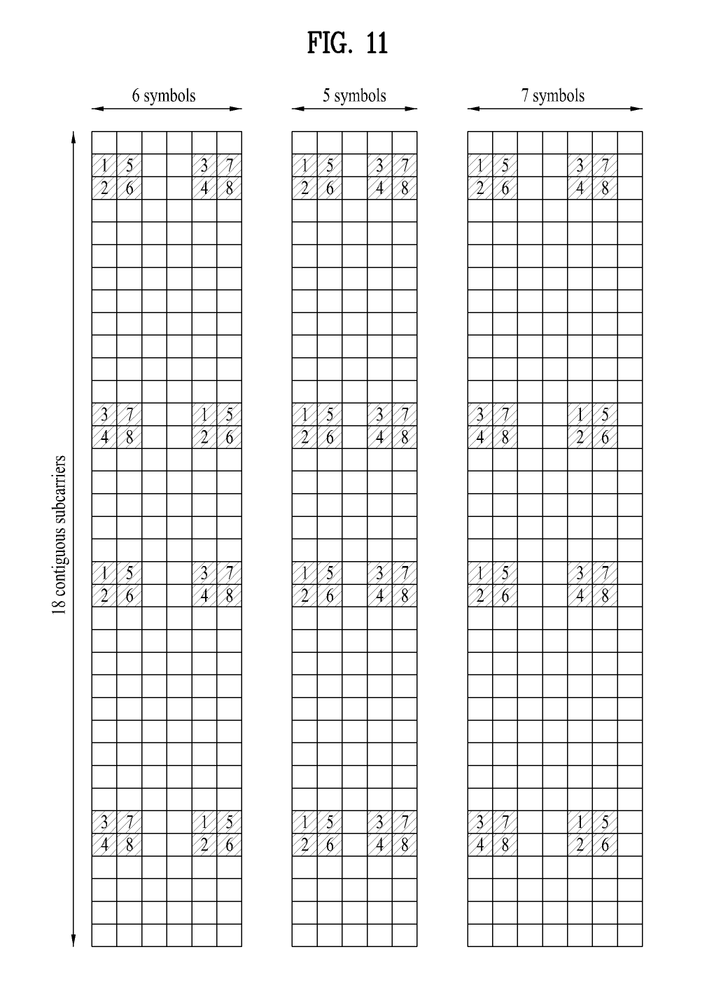

A subframe carries one or data/transmit streams, and carries pilot signal(s) allocated thereto in one of pilot pattern sets illustrated in FIGS. 1 to 11. According to Method 2, a ratio of the total power of pilot tones to the total power of data tones on the subframe is fixed to one value according to the number of streams. For example, for one or two data streams, the ratio of the total power of the pilot signal to the total power of the data signal on the subframe is preset to 1.58:1. For another example, for three to eight streams, the ratio of the total power of the pilot signal to the total power of the data signal on the subframe is preset to 1:1.

One thing to note herein is that the pilot power should be higher than the data power in case of an interlaced pilot pattern (e.g. for one or two streams) because data and pilots collide between different cells.

Table 2 below illustrates an example of setting a pilot boosting level on the uplink according to Method 1.

TABLE 2

| Total number of | | Power | Pilot | |
|---|---|---|---|---|
| data streams in | Number of data | per data | boosting | |
| single cell | streams for UE | stream | level | Pilot power |
| 1 | 1 | 1 | 0 dB | 1 |
| 2 | 1 | 1 | 0 dB | 1 |
| 2 | 2 | 0.5 | 3 dB | 1 |
| 3 | 1 | 1 | 0 dB | 1 |
| 3 | 2 | 0.5 | 3 dB | 1 |
| 3 | 3 | 0.3333 | 4.8 dB | 1 |
| 4 | 1 | 1 | 0 dB | 1 |
| 4 | 2 | 0.5 | 3 dB | 1 |
| 4 | 3 | 0.3333 | 4.8 dB | 1 |
| 4 | 4 | 0.25 | 6 dB | 1 |

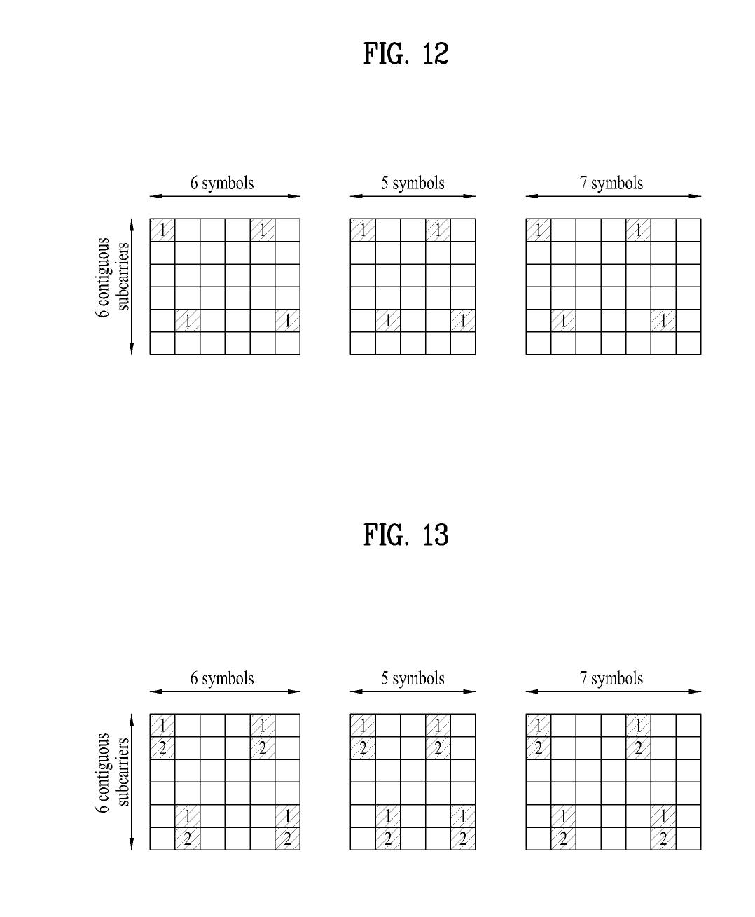

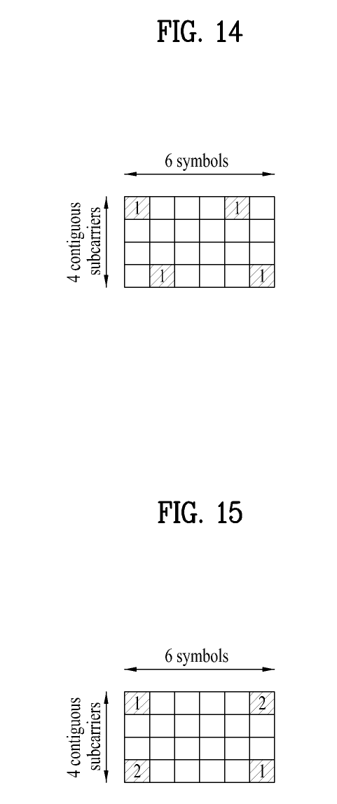

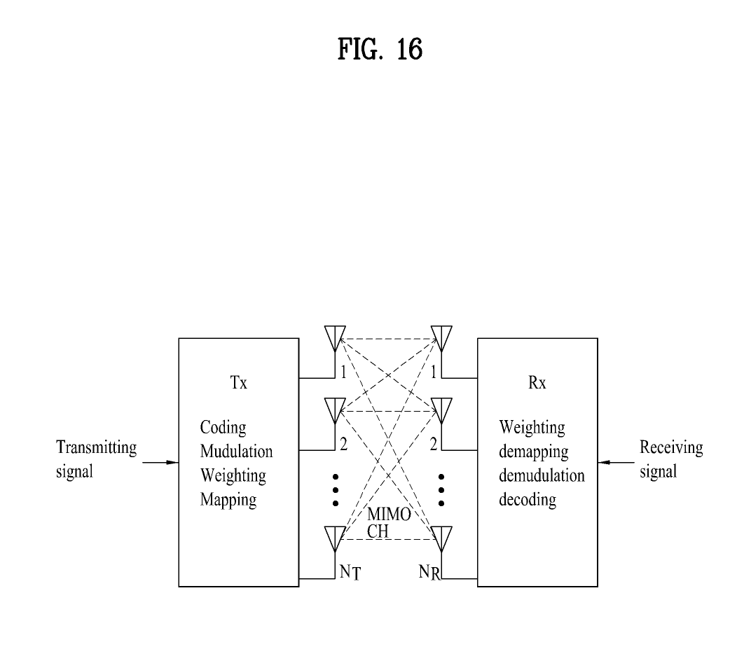

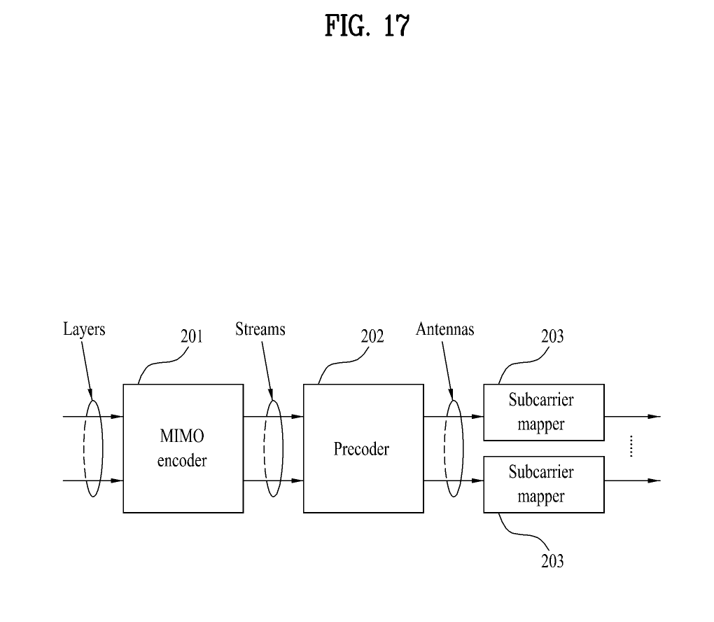

Referring to Table 2, for uplink transmission of N data streams, for example, the power per data stream is 1/N and the pilot power per data stream is fixed to 1. As the definition mentioned above, the power boosting level can be defined as 10*log(pilot power/(power per data stream). For example, for two data streams for two UEs, the power boosting level is 10*log(1/0.5)=3 dB. A subframe carries one or more data/transmit streams, and carries corresponding pilot signal(s) allocated thereto in one of pilot patterns illustrated in FIGS. 12 to 15. According to Table 2, a ratio of the total power of pilot signal to a total power of data signal on the subframe is fixed to one value according to the number of streams.

As stated before, the pilot boosting level may be defined as a pilot power relative to a data tone power. In other words, the pilot boosting level may be defined as power of pilot subcarrier relative to average power of data subcarrier on corresponding data stream.

Further, the following two methods for setting a pilot boosting level may be used for the downlink.

Table 3 illustrates an example of setting pilot boosting levels according to third and fourth methods (Method and Method 4) according to embodiments of the present invention.

TABLE 3

| | | Method 3 | | Method 4 | |
|---|---|---|---|---|---|
| Number of | | Pilot | | Pilot | |
| data | Data tone | boosting | Pilot | boosting | Pilot |
| streams | power | level | power | level | power |
| 1 | 1 | 5 dB | 3.16 | 2 dB | 1.58 |
| 2 | 1 | 2 dB | 1.58 | 2 dB | 1.58 |
| 3 | 1 | 1.2 dB | 1.33 | 0 dB | 1 |
| 4 | 1 | 0 dB | 1.00 | 0 dB | 1 |
| 5 | 1 | −1 dB | 0.80 | 0 dB | 1 |
| 6 | 1 | −1.8 dB | 0.66 | 0 dB | 1 |
| 7 | 1 | −2.4 dB | 0.57 | 0 dB | 1 |
| 8 | 1 | −3 dB | 0.50 | 0 dB | 1 |

Referring to [Table 3], a pilot boosting level is fixed with respect to a power per stream in Method 3.

According to Method 3, a large number of streams are allocated to a user in a good channel status, that is, a user with a high long-term SNR. Channel estimation performance increases with the long-term SNR. Therefore, if the number of streams increases, the channel estimation performance is maintained despite a decreased pilot power.

Method 4 is to fix the pilot power. The total transmit power of OFDM symbols varies with the number of streams. Accordingly, Method 4 maintains the total transmit power of OFDM symbols according to the number of streams.

One thing to note herein is that the pilot power should be higher than the data power in case of an interlaced pilot pattern (e.g. for one or two streams) because data and pilots collide between different cells.

Table 4 below illustrates an example of setting a pilot boosting level on the uplink according to Method 4.

TABLE 4

| Total number | | | | |
|---|---|---|---|---|
| of data | Number of | | Pilot | |
| streams in | data streams | Power per | boosting | |
| single cell | for UE | data stream | level | Pilot power |
| 1 | 1 | 1 | 0 dB | 1 |
| 2 | 1 | 1 | 0 dB | 1 |
| 2 | 2 | 1 | 0 dB | 1 |
| 3 | 1 | 1 | 0 dB | 1 |
| 3 | 2 | 1 | 0 dB | 1 |
| 3 | 3 | 1 | 0 dB | 1 |
| 4 | 1 | 1 | 0 dB | 1 |
| 4 | 2 | 1 | 0 dB | 1 |
| 4 | 3 | 1 | 0 dB | 1 |
| 4 | 4 | 1 | 0 dB | 1 |

According to the above-described pilot power controlling methods, channel estimation effects are enhanced by appropriate control of pilot power.

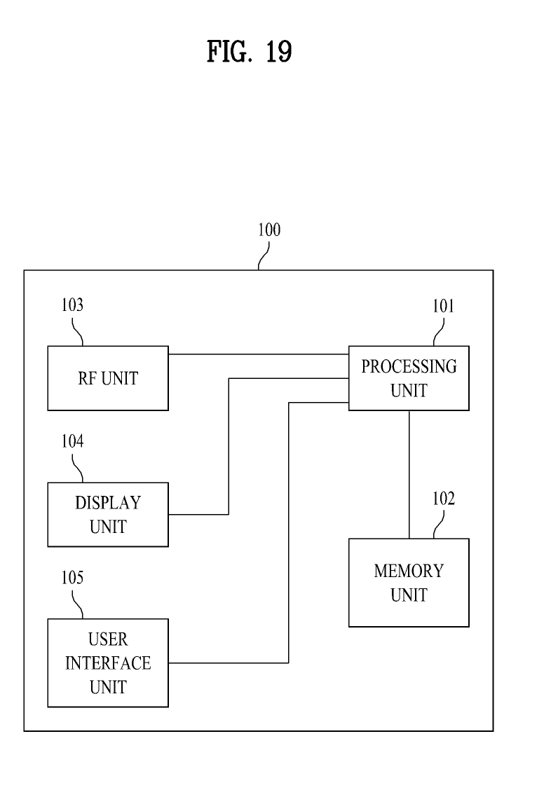

FIG. 19 is a block diagram of a device applicable to both a BS and a UE, for implementing the present invention.

Referring to FIG. 19, a device 100 includes a processing unit 101, a memory unit 102, a Radio Frequency (RF) unit 103. The device 100 can further include a display unit 104 and/or a user interface unit 105. The device 100 can be equipped in a base station or in a user equipment.

The processing unit 101 takes charge of implementing a physical interface protocol layer. The processing unit 101 provides a control plane and a user plane. The functionality of each layer may be carried out in the processing unit 101. The processing unit 101 may implement the above-described embodiments of the present invention. Specifically, the processing unit 101 may generate subframes for determining a location of a UE or determine the location of a UE by receiving the subframes.

The memory unit 102 is electrically connected to the processing unit 102, for storing an Operating System (OS), application programs, and general files.

If the device 100 is a UE, the display unit 104 may display various information. The display unit 104 may be configured into a Liquid Crystal Display (LCD), an Organic Light Emitting Diode (OLED), etc.

The user interface unit 105 may be configured with a known user interface such as a keypad, a touch screen, or the like.

The RF unit 103 is electrically connected to the processing unit 101, for transmitting and receiving RF signals.

The processing unit 101, the memory unit 102, the RF unit 103 and the display unit 104 are operably coupled to each other, and the processing unit 101 controls the operations of the memory unit 102, the RF unit 103 and the display unit 104.

The processing unit 101 can determine/set a power of pilot signal(s) transmitted in one of the pilot pattern sets illustrated in FIGS. 1 to 15. The processing unit can determine/set the power of pilot signal(s) according to one of Method 1 to 4. The processing unit can control the RF unit 103 to transmit the pilot signal(s) and corresponding data signal(s) on a subframe with the determined/set power.

For example, according to Method 2, the processing unit can set the power of the pilot signal such that the ratio of the power of pilot signal to the power of data signal on the subframe is equal to a predefined value. For example, for downlink transmission of one or two data streams, the processing unit 101 can set the power of the pilot signal such that the ratio of the power of the pilot signal to the power of the data signal on the subframe is 1.58:1. For downlink transmission of three to eight streams, the processing unit 101 can set the power of the pilot signal such that the ratio of the power of the pilot signal to the power of the data signal on the subframe is 1:1. For uplink transmission of one to four streams, the processing unit 101 can set the power of the pilot signal such that the ratio of the power of the pilot signal to the power of the data signal on the subframe is 1:1. Under the control of the processing unit 101, the RF unit transmits, on the subframe, the pilot signal with the power of the pilot power and the data signal with power of the data signal where the ratio of the power of the pilot signal to the power of the data signal is equal to a predefined value.

As is apparent from the above description, the present invention can increase channel estimation performance by appropriately controlling pilot power.

Exemplary embodiments described hereinbelow are combinations of elements and features of the present invention. The elements or features may be considered selective unless otherwise mentioned. Each element or feature may be practiced without being combined with other elements or features. Further, an embodiment of the present invention may be constructed by combining parts of the elements and/or features. Operation orders described in embodiments of the present invention may be rearranged. Some constructions of any one embodiment may be included in another embodiment and may be replaced with corresponding constructions of another embodiment. It is obvious to those skilled in the art that claims that are not explicitly cited in each other in the appended claims may be presented in combination as an exemplary embodiment of the present invention or included as a new claim by a subsequent amendment after the application is filed.

The term ‘UE’ may be replaced with the term ‘Mobile Station (MS)’, ‘Subscriber Station (SS)’, ‘Mobile Subscriber Station (MSS)’, or ‘terminal’.

The UE may be any of a Personal Digital Assistant (PDA), a cellular phone, a Personal Communication Service (PCS) phone, a Global System for Mobile (GSM) phone, a Wideband CDMA (WCDMA) phone, a Mobile Broadband System (MBS) phone, etc.

Exemplary embodiments of the present invention may be achieved by various means, for example, hardware, firmware, software, or a combination thereof.

In a hardware configuration, the methods according to exemplary embodiments of the present invention may be achieved by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, the methods according to the exemplary embodiments of the present invention may be implemented in the form of a module, a procedure, a function, etc. performing the above-described functions or operations. A software code may be stored in a memory unit and executed by a processor. The memory unit is located at the interior or exterior of the processor and may transmit and receive data to and from the processor via various known means.

Those skilled in the art will appreciate that the present invention may be carried out in other specific ways than those set forth herein without departing from the spirit and essential characteristics of the present invention. The above embodiments are therefore to be construed in all aspects as illustrative and not restrictive.

The scope of the invention should be determined by the appended claims and their legal equivalents, not by the above description, and all changes coming within the meaning and equivalency range of the appended claims are intended to be embraced therein.

What is claimed is:

1. A method for transmitting a pilot signal in a Multiple Input Multiple Output (MIMO) wireless communication system, the method comprising:
setting a power for a pilot signal to be transmitted in a pilot pattern; and
transmitting a subframe including one or more data streams and the pilot pattern of the pilot signal,
wherein a ratio of a total power of the pilot signal to a total power of the one or more data streams is preset in the system.

2. The method according to claim 1, wherein for one or two data streams, the ratio of the total power of the pilot signal to the total power of the data streams is preset to 1.58:1.

3. The method according to claim 1, wherein for three to eight streams, the ratio of the total power of the pilot signal to the total power of the data streams is preset to 1:1.

4. The method according to claim 2, wherein the pilot signal is transmitted on a downlink.

5. The method according to claim 3, wherein the pilot signal is transmitted on a downlink.

6. The method according to claim 1, wherein for one to four streams, the ratio of the total power of the pilot signal to the total power of the data streams is preset to 1:1.

7. The method according to claim 6, wherein the pilot signal is transmitted on an uplink.

8. A base station in a Multiple Input Multiple Output (MIMO) wireless communication system, comprising:
a processor configured to determine a power for a pilot signal to be transmitted in a pilot pattern; and
a transmitter, electrically connected to the processor, configured to transmit a subframe including one or more data streams and the pilot pattern of the pilot signal;
wherein a ratio of a total power of the pilot signal to a total power of the one or more data streams is preset in the system.

9. The base station according to claim 8, wherein for one or two data streams, the ratio of the total power of the pilot signal to the total power of the data streams is preset to 1.58:1.

10. The base station according to claim 8, wherein for three to eight streams, the ratio of the total power of the pilot signal to the total power of the data streams is preset to 1:1.

11. A user equipment in a Multiple Input Multiple Output (MIMO) wireless communication system, comprising:
a processor configured to determine a power for a pilot signal to be transmitted in the a pilot pattern; and
a transmitter, electrically connected to the processor, configured to transmit a subframe including one or more data streams and the pilot pattern of the pilot signal;
wherein a ratio of a total power of the pilot signal to a total power of the one or more data streams is preset in the system.

12. The user equipment according to claim 11, wherein for one to four streams, the ratio of the total power of the pilot signal to the total power of the data streams is preset to 1:1.
